(19) United States
(12) Patent Application Publication
(10) Pub. No.: US 2017/0260811 A1
(43) Pub. Date: Sep. 14, 2017

(54) Automatic savety pool ladder for an above-ground swimming pool

(71) Applicant: Canadian Plastics Inc., LaSalle (CA)

(72) Inventors: Pierre Trudeau, Lawrenceville (CA); Guylaine Lussier, Lawrenceville (CA)

(73) Assignee: Canadian Plastics Inc., LaSalle (CA)

(21) Appl. No.: 15/330,740

(22) Filed: Nov. 2, 2016

(30) Foreign Application Priority Data
Mar. 10, 2016 (CA) 2923280

(51) Int. Cl. E06C 7/00; E06C 1/26

(52) U.S. Cl. CPC E06C 7/006; E06C 1/26

(57) ABSTRACT

The present invention relates to an automatic safety pool ladder for an above-ground swimming pool composed of a set of rotative self-closing steps where the retracted position prevents access to water and where access to open steps is easily controlled by user through a lever arm and positioned so that the arm is not accessible to children.

This application is based on the foreign priority of Canadian Application No. 2,923,280, filed Mar. 10, 2016.

### BACKGROUND OF THE INVENTION

Safety pool ladders for above-ground swimming pools are known in the prior art. One well known type of safety pool ladder for above-ground swimming pools is described in patent documents U.S. Pat. No. 3,908,795, to Gannon (Sep. 30, 1975) and US20130025042A1, to Lin et Al. (Jan. 31, 2013). This type of safety pool ladder is generally represented by a substantially A-shaped ladder disposed in a saddle-like manner over the pool wall of a conventional above-ground swimming pool. The safety pool ladder typically has a relatively small horizontal platform at the top, and a set of ladder steps or rungs on each side of its A-shaped configuration, for climbing over the pool wall from either side thereof.

Furthermore, the set of ladder steps or rungs on the outside of the pool are mounted to a pair of parallel ladder side members having their upper ends pivotably attached to an upper portion of the A-shaped ladder. Thus, a user may selectively pivot this assembly upwardly when the pool must not be accessed unattended by an adult.

This type of safety pool ladder of the prior art, with its ladder steps and side members assembly thus pivoted upwardly, has the disadvantage of being relatively unstable during strong wind conditions, to a point of sometimes rolling over and tumbling out of the pool if not well anchored. This type of safety ladder further requires sufficient space near the pivotable assembly outside the pool, for allowing the relatively long pair of ladder side members to freely pivot upwardly. Finally, this type of safety ladder, with its ladder steps and side members assembly pivoted upwardly does not always particularly blend well aesthetically with pool side design furniture.

Another known type of safety pool ladder for above-ground swimming pools is described in patent documents U.S. Pat. No. 8,191,682B2, to Lipniarski (Jun. 5, 2012), U.S. Pat. No. 8,430,205B2, to Leung (Apr. 30, 2013), and FR2986032, to Bouillet (Jan. 23, 2012). This type of safety ladder also has a substantially A-shaped configuration, with a relatively small horizontal platform at the top and sets of ladder steps or rungs on each side thereof. This type of safety ladder further has a deployable or otherwise removably attachable cover that a user may selectively use to hide or at least block access to the set of ladder steps on the outer side of the pool wall, in order to prevent access to the pool.

This type of safety pool ladder solve some of the disadvantages of the previously described type of safety pool ladder by being more stable during strong wind conditions, requiring only limited space to be functional, and being more aesthetically appealing. On the other hand, this type of safety pool ladder may be less secure since it may allow some determined 7-8 year old kids to have unattended access to the pool by slightly jumping up to grab a lower part of the handrails typically positioned on each side of the platform, and using the step cover as a climbing ramp means that provides sufficient support adherence under their running shoes for relatively easily climbing the ladder.

Thus, there is a need for an improved automatic safety pool ladder for above-ground swimming pools. In a broad aspect, the present invention provides such an improved automatic safety pool ladder that avoids the aforementioned disadvantages.

### SUMMARY OF THE INVENTION

In a broad aspect, the present invention provides an improved automatic safety pool ladder for an above-ground swimming pool. The swimming pool defines a pool wall extending upwardly above ground, a pool bottom and a pool peripheral ground extending substantially adjacently around the pool wall.

According to an embodiment of the present invention, the automatic safety pool ladder generally comprises a stationary ladder assembly and a rotative ladder assembly.

The stationary ladder assembly includes a pair of ladder side members. Each one in the pair of ladder side members has substantially an open trapezoidal configuration defined by a substantially vertically extending ladder side in-pool leg portion and a substantially vertically extending ladder side ground engaging leg portion, that are joined through the upper ends thereof by a ladder side apex portion extending therebetween.

Each one in the pair of ladder side members is disposed in a parallelly spaced apart relationship relative to the other one, with a ladder platform extending between the ladder side apex portions thereof, and a set of stationary ladder step members extending horizontally between the pair of ladder side in-pool leg portion, and disposed in an equidistantly spaced apart relationship therealong.

The rotative ladder assembly includes a set of rotative rungs fixed in guide holes inside the pair of ladder side members. A spring is placed on the bottom of one of the ladder side to hold the mechanism in secure position.

When in closed position, rungs forms a flat surface, preventing climbing.

Each ladder assembly step member is joined in a parallelly spaced apart relationship relative to the other ones through a rod extending parallelly between each adjacent ends thereof, this rod fixed to a lever permitting controlled rotation. The lever end is placed along the platform, out of the reach of children.

Hence, when the lever is pulled down in the ladder deployed position, a user standing on the pool peripheral ground can climb the safety pool ladder.

The weight of users is enough to let the rungs stay in open position, permitting to climb to the top platform without being preoccupied with the lever.

Then, without weight on any rung, the spring let the lever to be automatically released in normal position, letting reset all rungs in flat position.

When the lever is released in the ladder retracted position, a user standing on the pool peripheral ground is prevented from climbing the safety pool ladder.

Thus, the automatic safety pool ladder for above-ground swimming pools of the present invention is relatively stable during strong winds, requires only limited space to be functional, is more likely to be aesthetically appealing among pool side design furniture and, most importantly, may discourage very determined young kids from accessing an unattended above-ground swimming pool.

Other advantages, novel features and alternate embodiments of the present invention will be more apparent from the following drawings and detailed description.

### BRIEF DESCRIPTION OF THE DRAWINGS

FIG. 1, in a perspective view, illustrates an embodiment of an automatic safety pool ladder, according to the present invention;

FIG. 2, in a perspective view, illustrates an automatic safety pool ladder, here shown in a retracted position;

FIG. 3, in a partial, side cross-sectional view, illustrates an embodiment of a rotative ladder assembly, here shown with the rotative ladder assembly (rungs) moved in its retracted position;

FIG. 4, in a partial, side cross-sectional view, illustrates another embodiment of a retractable ladder assembly, here shown with the rotative ladder assembly (rungs) moved to its open position;

FIG. 5, in a partial, front elevational view, illustrates the rotative ladder assembly in FIG. 3;

FIG. 6, in a partial side cross-sectional view, illustrates the rotative ladder assembly in FIG. 3, here shown provided with a lock means for locking the rotative ladder assembly in a retracted position.

### DETAILED DESCRIPTION OF THE INVENTION

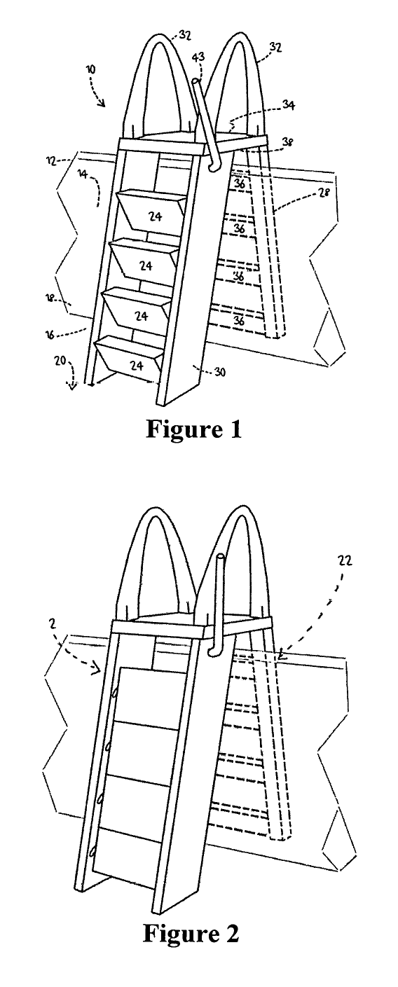

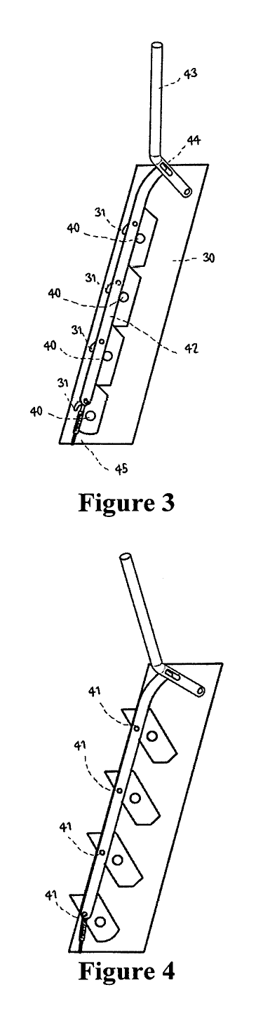

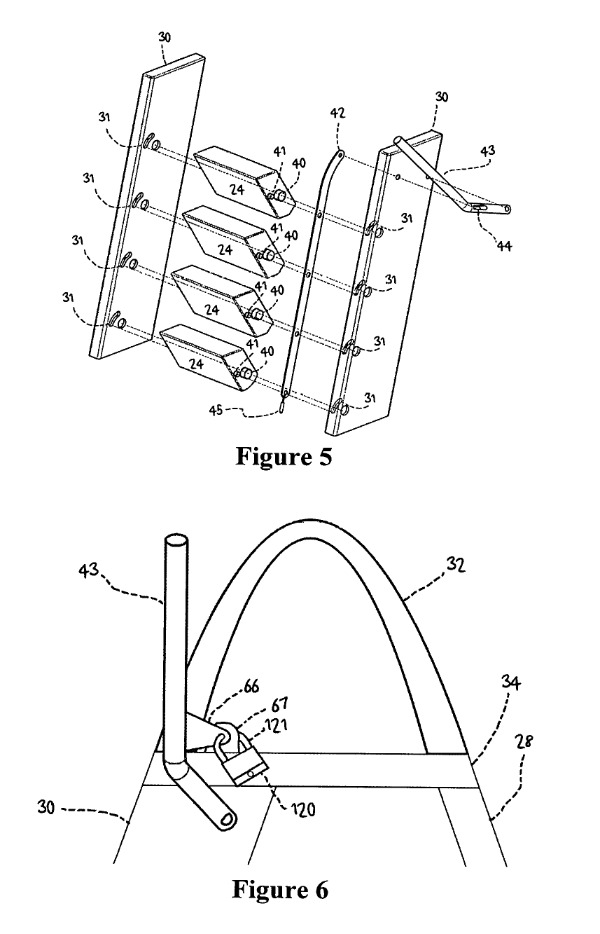

FIG. 1 illustrates various aspects of an embodiment, according to the present invention, of a safety pool ladder 10 for an above-ground swimming pool 12.

The swimming pool 12 defines a pool wall 14 extending upwardly above ground 16, a pool bottom 18 and a pool peripheral ground 20 extending substantially adjacently around the pool wall 14.

Now referring more particularly to FIGS. 1 and 2 respectively, the safety pool ladder 10 generally comprises a stationary ladder assembly 22 and a rotative ladder steps assembly 24.

The stationary ladder assembly 22 has substantially an open trapezoidal configuration defined by a substantially vertically extending ladder side in-pool leg portion 28 and a substantially vertically extending ladder side ground engaging leg portion 30, that are joined through the upper ends thereof by a ladder side apex portion 32 extending therebetween.

Each one in the pair of ladder side members 22 is disposed in a parallelly spaced apart relationship relative to the other one.

The stationary ladder assembly 22 further includes a ladder platform 34 extending horizontally between the ladder side members and substantially adjacently the ladder side apex portions 32 thereof.

The stationary ladder assembly 22 further includes a set of stationary ladder step members 36 extending horizontally between the pair of ladder side in-pool leg portions 28, and disposed in an equidistantly spaced apart relationship therealong.

Furthermore, the stationary ladder assembly 22 defines an underside trapezoidal outline 38 substantially circumscribed by the parallelly extending ladder side in-pool leg portions 28, the platform 34, and the parallelly extending ladder side ground engaging leg portions 30.

The rotative step ladder 24 has substantially a parallelepiped shape.

In addition, a protrusive rotation axis 40 is placed on each side of the steps 24 and fits into the lateral leg portions 30.

Another control axis 41 is placed on one of the sides of the steps 24 and is inserted into the guide rod 42, this one is placed inside one of the leg portion 30.

The guide rod 42 is pierced at equal distance to allow the insertion of control axis 41 of each step 24, allowing steps to be fixed by their control axis 41 equidistantly and leave no opening between each of the steps when in retracted position. It also allows maneuvering all the steps in unison.

Furthermore, this guide rod 42 is connected by a pivot 44 to the lever 43. This lever 43 protrudes on the top side of the ladder side apex portion 32.

This lever 43 stands normally in a vertical position when in retracted position. When the user lowers a few degrees the lever 43, its drag along the guide rod 42 by moving the series of steps in their open position, which allows the user to ascend or descend.

Furthermore, control axis 41 are retained in good place in their displacement by lunar-shaped slots 31 in the lateral leg portion 30 who receive the mechanism.

Also, this guide rod 42 is connected to a compression spring 45 which allows to retain the steps in their retracted position. This spring is strong enough to hold up steps closed, but enough relaxed to not cause too much tension on the lever 43.

Hence, when the rotative ladder assembly 10 is in the ladder deployed position as illustrated in FIG. 1, a user standing on the pool peripheral ground 20 can climb the safety pool ladder 10. And when the rotative ladder assembly 60 is in the ladder retracted position as illustrated in FIG. 2, a user standing on the pool peripheral ground 20 is prevented from climbing the safety pool ladder 10.

As illustrated in FIG. 1, the safety pool ladder 10 is sufficiently sized and shaped for substantially stably standing over the pool wall 14 in a saddle-like configuration, with a lower end of the ladder side in-pool leg portions 28 resting on the pool bottom 18, and a lower end of the ladder side ground engaging leg portions 30 resting on the pool peripheral ground 20.

In some embodiments, as illustrated in FIG. 6, the safety pool ladder 10 further includes a lock means 120 along the lever 43, for locking the rotative ladder assembly 10 substantially in the retracted position.

For example, the lock means 120 may define a padlock aperture 66 configured and sized for engaging a locking member 121 of a padlock. The padlock aperture 66 may fit exactly through a side portion of a second padlock aperture that is suitably fixed on the platform 34 so as to block the movement of the lever 43, consequently to the rotative ladder assembly.

As would be obvious to someone familiar with locking means for slidable assemblies, such as doors and the like, other known types and arrangements for a locking means 120 are also possible.

In some embodiments, as illustrated in FIG. 1, the ladder side apex portion 32 of each one in the pair of ladder side members 30 is extending relatively higher than the platform 34 so as to define a pair of substantially rigid pool ladder side guardrails for safely helping users move across the platform 34.

In some embodiments, as best illustrated in FIGS. 1 and 2, the set of stationary ladder step members 36 has a substantially equivalent number of step members relative to the set of ladder assembly step members 24.

Although the above description contains many specificities, these should not be construed as limitations on the scope of the invention but is merely representative of the presently preferred embodiments of this invention.

1. An A-frame ladder for swimming pool comprising:
a stationary step ladder assembly adapted to be placed within said swimming pool;
a rotative step ladder assembly adapted to be placed outside of said swimming pool;
said stationary step and rotative step ladder assemblies are connected between each other at their top extremity by means of
a ladder platform;
wherein said rotative step ladder assembly is activated from its inoperable or closed position into operable or open position be means of
a rotative moving means;
wherein said rotative moving means are adapted to move steps of said rotative step ladder assembly into inoperable or closed position automatically by turning said steps into a flat surface configuration.

2. An A-frame ladder according to claim 1, wherein said rotative moving means comprises a guide rod adapted to rotate said steps from inoperable or closed position into operable open position by means of lever located on said ladder platform, said guide rod is adapted to lower said rotatable steps into operable position and wherein a weight of a user using those rotatable steps keeps said steps in operable position and wherein without the weight of said user said steps are automatically released into inoperable or closed position.

3. An A-frame ladder according to claim 2, wherein each step of said rotative step ladder assembly is adapted to be rotated by means of rotation axes incorporated between each of said steps and lateral supporting leg portions containing said rotative ladder assembly.

4. An A-frame ladder according to claim 3, wherein each step of said rotative step ladder assembly comprises a control axis connected between each of said steps and said guide rod, said control axis is adapted to rotate said corresponding step of rotatable ladder assembly from said inoperative or closed position into said operative or open position be means of downward movement of said guide rod.

5. An A-frame ladder according to claim 4, wherein in said inoperable position said lever stays in vertical position and wherein said lever is rotatably connected to said guide rod by means of a pivot mounted on said ladder platform.

6. An A-frame ladder according to claim 4, wherein said lateral supporting leg portions are provided by slots adapted to retain said control axes in said open position, wherein said slots have a lunar configuration.

7. An A-frame ladder according to claim 2, wherein a lower portion of said guide rod is connected to a compression spring, wherein said spring is adapted to retain said rotatable steps in inoperable or closed position when not in use.

8. An A-frame ladder according to claim 1, wherein said rotatable steps have a parallelepiped configuration.

9. An A-frame ladder for swimming pool comprising:
a stationary step ladder assembly adapted to be placed within said swimming pool;
a rotative step ladder assembly adapted to be placed outside of said swimming pool;
said stationary step and rotative step ladder assemblies are connected between each other at their top extremity by means of
a Ladder platform;
wherein said rotative step ladder assembly is activated from its inoperable or closed position into operable or open position be means of
a Rotative moving means;
wherein said rotative moving means are adapted to move steps of said rotative step ladder assembly into inoperable or closed position automatically by turning said steps into a flat surface configuration;
wherein said rotative moving means comprises a guide rod adapted to rotate said steps from inoperable or closed position into operable open position by means of a lever located on said ladder platform, said guide rod is adapted to lower said rotatable steps into operable position and wherein a weight of a user using those rotatable steps keeps said steps in operable position and wherein without the weight of said user said steps are automatically released into inoperable or closed position.

10. An A-frame ladder according to claim 9, wherein each step of said rotative step ladder assembly is adapted to be rotated by means of rotation axes incorporated between each of said steps and lateral supporting leg portions containing said rotative ladder assembly.

11. An A-frame ladder according to claim 10, wherein each step of said rotative step ladder assembly comprises a control axis connected between each of said steps and said guide rod, said control axis is adapted to rotate said corresponding step of rotatable ladder assembly from said inoperative or closed position into said operative or open position be means of downward movement of said guide rod.

12. An A-frame ladder according to claim 11, wherein in said inoperable position said lever stays in vertical position and wherein said lever is rotatably connected to said guide rod by means of a pivot mounted on said ladder platform.

13. An A-frame ladder according to claim 10, wherein said lateral supporting leg portions are provided by slots adapted to retain said control axes in said open position, wherein said slots have a lunar configuration.

14. An A-frame ladder according to claim 10, wherein a lower portion of said guide rod is connected to a compression spring, wherein said spring is adapted to retain said rotatable steps in inoperable or closed position when not in use.

15. An A-frame ladder according to claim 9, wherein said rotatable steps have a parallelepiped configuration.

16. An A-frame ladder for swimming pool comprising:
a stationary step ladder assembly adapted to be placed within said swimming pool;
a rotative step ladder assembly adapted to be placed outside of said swimming pool;
said stationary step and rotative step ladder assemblies are connected between each other at their top extremity by means of
a Ladder platform;
wherein said rotative step ladder assembly is activated from its inoperable or closed position into operable or open position be means of
a Rotative moving means;
wherein said rotative moving means are adapted to move steps of said rotative step ladder assembly into inoperable or closed position automatically by turning said steps into a flat surface configuration;
wherein said rotative moving means comprises a guide rod adapted to rotate said steps from inoperable or closed position into operable open position by means of lever located on said ladder platform, said guide rod is adapted to lower said rotatable steps into operable position and wherein a weight of a user using those rotatable steps keeps said steps in operable position and wherein without the weight of said user said steps are automatically released into inoperable or closed position;
wherein each step of said rotative step ladder assembly is adapted to be rotated by means of rotation axes incorporated between each of said steps and lateral supporting leg portions containing said rotative ladder assembly; and
wherein each step of said rotative step ladder assembly comprises a control axis connected between each of said steps and said guide rod, said control axis is adapted to rotate said corresponding step of rotatable ladder assembly from said inoperative or closed position into said operative or open position be means of downward movement of said guide rod.

17. An A-frame ladder according to claim 16, wherein in said inoperable position said lever stays in vertical position and wherein said lever is rotatably connected to said guide rod by means of a pivot mounted on said ladder platform.

18. An A-frame ladder according to claim 16, wherein said lateral supporting leg portions are provided by slots adapted to retain said control axes in said open position, wherein said slots have a lunar configuration.

19. An A-frame ladder according to claim 16, wherein a lower portion of said guide rod is connected to a compression spring, wherein said spring is adapted to retain said rotatable steps in inoperable or closed position when not in use.

20. An A-frame ladder according to claim 16, wherein said rotatable steps have a parallelepiped configuration.
